(19) United States
(12) Patent Application Publication
(10) Pub. No.: US 2026/0340797 A1
(43) Pub. Date: Oct. 29, 2026

(54) Method and system for evaluating modification effects of moderately and severely salinized farmland

(71) Applicants: Northeast Institute of Geography and Agroecology, Chinese Academy of Sciences, Changchun (CN); Institute of Applied Ecology, Chinese Academy of Sciences, Shenyang (CN)

(72) Inventors: Sicong MA, Changchun (CN); Feng ZHOU, Shenyang (CN); Lihua HUANG, Changchun (CN); Jian GU, Shenyang (CN); Risu NA, Changchun (CN); Lei ZHONG, Changchun (CN); Hongbo HE, Shenyang (CN); Ke HAN, Changchun (CN); Xiaowei YUAN, Shenyang (CN); Hongzhe GAO, Changchun (CN); Huijie LV, Shenyang (CN); Xudong ZHANG, Shenyang (CN); Donghua ZHAO, Changchun (CN); Liwei ZHAO, Shenyang (CN); Ruocheng JIN, Shenyang (CN)

(73) Assignees: Northeast Institute of Geography and Agroecology, Chinese Academy of Sciences, Changchun (CN); Institute of Applied Ecology, Chinese Academy of Sciences, Shenyang (CN)

(21) Appl. No.: 19/366,732

(22) Filed: Oct. 23, 2025

(30) Foreign Application Priority Data
Apr. 27, 2025 (CN) 2025105340262

(51) Int. Cl. G06T 7/00; G06T 7/13; G06V 10/26; G06V 10/40; G06V 10/75; G06V 10/764; G06V 10/774; G06V 20/10

(52) U.S. Cl. CPC G06T 7/0002; G06T 7/13; G06V 10/26; G06V 10/40; G06V 10/751; G06V 10/764; G06V 10/774; G06V 20/188; G06T 2207/10032; G06T 2207/20076; G06T 2207/20081; G06T 2207/20084; G06T 2207/30188

(57) ABSTRACT

The present invention relates to the technical field of arable land improvement effect evaluation, and specifically discloses a method and system for evaluating modification effect of moderately to severely salinized farmland land. The method comprises receiving an arable land range input by an administrator, randomly selecting evaluation points within the arable land range, and determining the evaluation level of the evaluation points; obtaining evaluation data containing point tags and time tags based on evaluation equipment installed at the evaluation points, and constructing an evaluation data matrix containing the point tags; receiving an evaluation instruction input by the administrator, extracting row data from the evaluation data matrix based on the input time of the evaluation instruction, analyzing the extracted row data, and outputting an evaluation result; and synchronously training an evaluation model based on the evaluation result.

### CROSS-REFERENCE

This application claims the benefit of priority from China Patent Application No. CN 2025105340262 filed on Apr. 27, 2025, the contents of which are hereby incorporated by reference in their entirety.

### TECHNICAL FIELD

The present invention relates to the technical field of farmland improvement effect judgment, and specifically a method and system for evaluating modification effects of moderately and severely salinized farmland.

### BACKGROUND TECHNOLOGY

Moderately and severely salinized farmland improvement is a complex and lasting process, it is necessary to monitor a plurality of indicators comprehensively to judge improvement effects and adjust modification measures in time.

During modification of moderately and severely salinized farmland, it is necessary to judge the modification effects, so as to change corresponding improvement measures to achieve better modification effects; however, modification effect judgment processes currently available are done in every stage, only after completion of a modification period, an overall judgment will be made, which is of low timeliness.

### SUMMARY OF THE INVENTION

The present invention aims to provide a method and system for evaluating modification effects of moderately and severely salinized farmland, to address the problems raised in the background.

To this end, the present invention provides the following technical solutions:

A method for evaluating modification effects of moderately and severely salinized farmland, wherein the method comprising:
receiving a farmland input by an administrator, selecting judgment points in the farmland randomly, and determining levels of the judgment points; wherein the levels are configured to determine data types of data to be acquired at the judgment points;
acquiring judgment data containing point tags and time tags based on judgment devices installed on the judgment points, building a judgment data matrix containing the point tags;
the time tags adopt relative time, and a zero moment comprises a moment when modification is started;
receiving judgment instructions from the administrator, extracting line data in the judgment data matrix based on the time when the judgment instructions are input, analyzing the line data extracted and outputting judgment results;
upon receipt of the judgment instructions from the administrator, acquiring remote sensing images synchronously, acquiring a remote sensing image at the moment when the modification is started as a baseline image, taking the baseline image and the remote sensing image as features, taking the judgment results as tags, and training a judgment model; adjusting an application probability of the judgment model and an application probability of an analysis process of the judgment data matrix according to an error rate of the judgment model.

As a further technical solution: receiving the farmland range input by the administrator, selecting judgment points randomly in the farmland range and determining the levels of the judgment points comprise:
receiving the farmland range input by the administrator;
rasterizing the farmland range, inserting a grid in the farmland range according to a predetermined unit size; lines at a left edge and an upper edge of the grid are tangent to the farmland range;
selecting nodes of the grid randomly as the judgment points, determining the levels of the judgment points;
updating a selection probability of the nodes of the grid and executing selection processes cyclically;
recording a total number of the judgment points selected, where the total number reaches a predetermined threshold, outputting the selected judgment points and the judgment levels thereof.

As a further solution of the present invention: updating the selection probability of the nodes of the grid and executing selection processes thereof comprises:

$$P ( i , j ) = \frac{T ( i , j )}{{\sum }_{i = 1}^{N} {\sum }_{j = 1}^{M} T ( i , j )} ;$$

wherein P(i, j) stands for a selection probability at a grid node (i, j), T(i, j) stands for a feature value at the grid node (i, j), N is a total number of the grid nodes on a transverse direction, M is a total number of the grid nodes on a longitudinal direction; i and j comprise positive integers;

$$T ( i , j ) = α exp \{ - {\sum }_{k = 1}^{K} \frac{{L}_{k}}{{dis}_{k} ( i , j )} \} ;$$

α stands for a preset rectification index, Lₖ comprises a judgment level of a kth judgment point selected; and disₖ(i, j) comprises a distance between the kth judgment point and the grid node (i, j);
where the grid node (i, j) is selected as the judgment point, L(i, j)=f(T(i, j)); in the formula, L(i, j) comprises the judgment level at the grid node (i, j), f(T(i, j)) comprises a classification function having an independent variable T(i, j) and is an increasing function of T(i, j).

As a further solution of the present invention: receiving the judgment instruction from the administrator, extracting line data from the judgment data matrix based on the time when the judgment instruction is input, analyzing the extracted line data, and outputting the judgment results comprises:
receiving the judgment instruction from the administrator, recording the moment when the judgment instruction is input;
extracting line data corresponding to the input moment;
traversing a standard data set and calculating a matching degree based on the line data;
using the matching degree as the judgment result at the input moment;
wherein the standard data set comprises a theoretical data range of all data types in different moments.

As a further solution of the present invention: traversing the preset standard data set based on the line data and calculating the matching degree comprises:
reading the standard data set at the input moment;
comparing the line data extracted from the judgment data matrix with the line data in a standard line data set and calculating a matching degree;
wherein, during comparison, complementing rows for the line data extracted from the judgment data matrix, and elements to be complemented comprise preset default values. As a further solution of the present invention: upon receipt of the judgment instruction from the administrator, acquiring the remote sensing images synchronously, acquiring the remote sensing image at a moment when modification is initiated as the baseline image, taking the baseline image and the remote sensing image as features, taking the judgment results as tags and training the judgment model; adjusting the application probability of the judgment model and the application probability of analysis of the judgment data matrix according to the error rate of the judgment model comprises:

acquiring the remote sensing image at the moment when the modification is initiated as the baseline image;
receiving the judgment instruction input by the administrator, acquiring the remote sensing images synchronously as the remote sensing image at the input moment;
taking the baseline image and the remote sensing image at the input moment as an image set, reading the judgment results at the input moment, and building a sample set; wherein the image set is a feature corresponding to an input, the judgment results comprise tags corresponding to an output;
training the judgment model based on the sample set and adjusting the application probability of the judgment model and the application probability of the analysis process of the judgment data matrix according to the error rate of the judgment model;
wherein the application probability of the judgment model varies inversely with the error rate, and the application probability of the analysis process of the judgment data matrix varies in direct proportion to the error rate.

The present invention further provides a system for evaluating modification effects of moderately and severely salinized farmland, wherein the system comprises:
a judgment point allocating module, configured to receive the farmland range input by the administrator, select judgment points randomly in the farmland range and determining the levels of the judgment points; wherein the levels are configured to determine data types of the data to be acquired at the judgment points;
a data matrix building module, configured to acquire the judgment data containing the point tags and the time tags using judgment devices installed on the judgment points, and building a judgment data matrix containing the point tags; wherein the time tags use relative time, a zero moment is the moment the modification is initiated; a row number of the judgment data matrix is the same as a total number of the data types, and the line number corresponds to the time;
a line data analysis module, configured to receive the judgment instruction input by the administrator, extracting line data from the judgment data matrix based on the input moment of the judgment instruction, analyzing the extracted line data and outputting judgment results;
a model training application module, configured to acquire remote sensing images upon receipt of the judgment instruction input by the administrator, acquire the remote sensing images at the moment when the modification is initiated as the baseline image, take the baseline image and the remote sensing images as the feature, take the judgment results as the tags, and train the judgment model; and adjust the application probability of the judgment model and the application probability of the analysis process of the judgment data matrix according to the error rate of the judgment model.

As a further solution of the present invention: the judgment point allocating module comprises:
a range receiving unit, configured to receive the farmland range input by the administrator;
a grid input unit, configured to rasterize the farmland range, and insert a grid on the farmland range according to the preset unit size; and lines at a left edge and an upper edge of the grid are tangent to the farmland range;
a random selection unit, configured to select grid nodes randomly as the judgment points and determine the judgment levels of the judgment points synchronously;
a cyclic execution unit, configured to update a selection probability of the grid nodes and execution the selection process periodically;
a first input unit, configured to record a total number of the judgment points selected, and when the total number reaches a preset threshold, outputting the judgment points selected and the judgment levels thereof.

As a further solution of the present invention: the line data analysis module comprises:
an instruction receipt unit, configured to receive the judgment instruction input by the administrator, and record the input moment of the judgment instruction;
a line data extraction unit, configured to extract line data corresponding to the input moment from the judgment data matrix;
a traversing matching unit, configured to traverse the preset standard dataset and calculate a matching degree;
a first input unit, configured to take the matching degree as the judgment results of the input moment;
wherein the standard dataset comprises a preset theoretical data range of all the data at different times.

As a further solution of the present invention: the model training application module comprises:
a baseline image acquisition unit, configured to acquire the remote sensing images at the initiating moment as the baseline image;
a real-time image acquisition unit, configured to acquire the remote sensing images synchronously upon receipt of the judgment instruction input by the administrator as the remote sensing image at the input moment;
a sample set construction unit, configured to take the baseline image and the remote sensing image at the input moment as the image set, read the judgment results at the input moment, and build a sample set; wherein the image set corresponds to a feature, which is an input and the judgment result is a tag, corresponds to an output;
an application probability updating unit, configured to train the judgment model based on the sample set, and adjust the application probability of the judgment model and the application probability of the analysis process of the judgment data matrix according to the error rate of the judgment model;
wherein the application probability of the judgment model varies inversely with the error rate, and the application probability of the analysis process of the judgment data matrix is in direct proportion to the error rate of the judgment model.

Compared with the prior art, the beneficial effects of the present invention are: by installing data acquisition devices on the farmland, acquiring soil data remotely, judging the modification effects in real time, simultaneously, training the neural network model based on remote sensing images based on the judgment results, recognition speed is further improved, timeliness is high, and when it is necessary, the administrator can be acquainted with the judgment effects of the current moments.

### BRIEF DESCRIPTION OF DRAWINGS

To illustrate the technical solutions in the embodiments of the present invention more clearly, hereinafter the drawings to be used for the description of the embodiments or the prior art will be briefly introduced herein, apparently the drawings given here are only some embodiments of the present invention rather than all.

FIG. 1 is a schematic flowchart diagram showing a judgment method of moderate and severe salinized farmland modification effects.

FIG. 2 is a schematic structural diagram showing components of a judgment system of moderate and severe salinized farmland modification effects.

### EMBODIMENTS

To further clarify the technical problems, technical solutions, and beneficial effects to be solved by the present invention, the present invention is further described in detail below with reference to the accompanying drawings and embodiments. It should be understood that the specific embodiments described herein are intended only to illustrate the present invention and are not intended to limit the present invention.

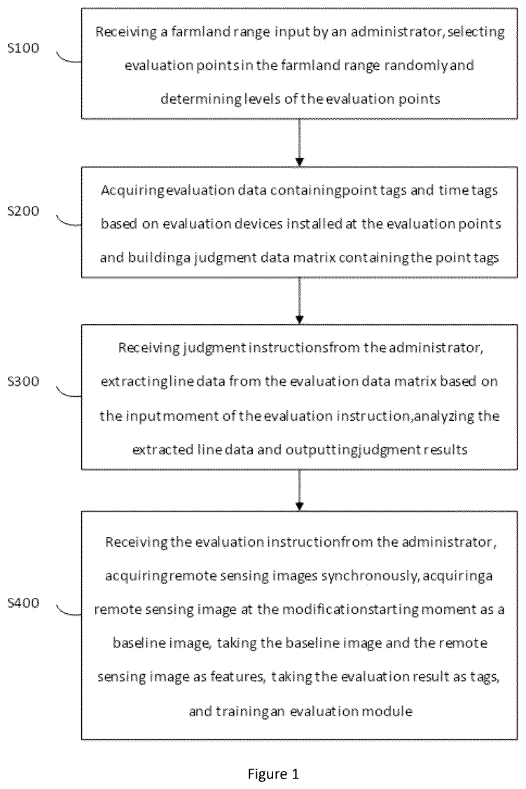

FIG. 1 is a flow chart of a method for evaluating modification effects of moderately to severely salinized farmland. In an embodiment of the present invention, a method for evaluating modification effects of moderately to severely salinized farmland comprises:

Step S100: receiving a farmland range input by an administrator, randomly selecting evaluation points within the farmland range, and determining the evaluation level of the evaluation points; the evaluation level is used to determine the data type of the data to be acquired at the evaluation points.

The technical solution of the present invention is applied to farmland improvement scenarios, specifically, the improvement of moderately to severely salinized farmland. Any improvement process is done to a range, i.e., the range of the farmland to be improved. This range is input by the administrator and comprises generally a set of boundary coordinates.

The input method can be to enter a coordinate set and then fit the coordinates in the coordinate set to obtain the farmland range. Alternatively, another method is to directly input a touch screen signal to directly enter the range. A farmland area is delineated. Once the farmland area is determined, several points within the area are selected as evaluation points. Information collection equipment is installed at these evaluation points to collect soil parameters. The type of soil data collected at different evaluation points varies, determined by the evaluation level parameter. The higher the evaluation level, the more types of information collection equipment are installed, and the greater the type of data collected. In the technical solution of the present invention, soil parameters generally include soil salinity, soil pH, soil organic matter content, soil texture, and soil microbial indicators. In addition, crop growth parameters, such as vegetation cover and crop physiological parameters, may also be included. Sensors for these parameters are currently available and some specific examples are as follows:

### Soil Salt Content:

Conductivity Sensors: employed to indirectly measure salt content by measuring the conductivity of the soil solution. Because salt ions in the soil solution are conductive, conductivity is positively correlated with salt content. Commonly used conductivity sensors include four-electrode conductivity sensors, which can be buried in the soil for real-time measurement.

Near-Infrared Spectroscopy Sensors: employed to utilize the soil's absorption of near-infrared light to infer salt content. Different salts have specific absorption peaks in the near-infrared band, and salt concentration can be estimated by analyzing the reflectance spectrum. These sensors can be mounted on drones or ground vehicles for rapid large-scale monitoring.

### Soil pH (pH):

Glass electrode pH sensor: Based on the ion exchange principle, when a glass electrode comes into contact with a soil solution, hydrogen ions are exchanged on the glass membrane surface, generating a potential difference. This potential difference can be measured to calculate the soil pH. The electrode is inserted into the soil extract for measurement during use.

Optical fiber pH sensor: utilizing a pH-sensitive fluorescent material, when the fluorescent material comes into contact with a soil solution, its fluorescence intensity or wavelength changes with pH. The optical signal is transmitted via optical fiber for detection and analysis, enabling real-time, in-situ monitoring of soil pH.

### Soil Organic Matter Content:

Near-infrared spectroscopy-based sensors: Organic matter in soil has characteristic absorption peaks in the near-infrared spectral region. By collecting soil near-infrared spectra and developing corresponding prediction models, soil organic matter content can be quickly estimated.

Thermogravimetric analyzers (ex situ real-time monitoring): In the laboratory, soil samples are heated under a temperature program and the change in sample masses is measured to determine organic matter contents. While not a real-time on-site sensor, they provide highly accurate results and can be used to calibrate other rapid detection methods.

### Soil Texture:

Laser particle size analyzers: Soil texture is determined by measuring the angle and intensity of light scattered by laser light in a suspension of soil particles and calculating the particle size distribution based on the Mie scattering theory. This instrument requires laboratory soil sample processing and measurement.

Time domain reflectometry (TDR) combined with a model: TDR is primarily used to measure soil moisture content, but soil texture can be indirectly estimated by developing empirical models related to soil texture and combining them with information such as the dielectric constant measured by TDR.

### Soil Microbial Information:

Microbial sensors: Based on the biochemical reaction between microorganisms and specific substrates, these reactions are converted into detectable electrical or optical signals. For example, specific microorganisms are immobilized on the surface of an electrode. When the target substrate in the soil solution reacts with the microorganisms, the electrode potential or current changes, thereby detecting microbial activity or the concentration of the substrate.

It is worth noting that the cost of different sensors varies. To improve the alignment of the selection process for evaluation points with actual conditions, cost can be used as a parameter when determining the evaluation level of the evaluation point. In other words, the evaluation level corresponds to cost; the higher the evaluation level, the higher the cost. Based on the determined cost, information collection equipment is combined and installed at the evaluation point. When combining information collection equipment based on the determined cost, the combination that maximizes the number of information collection devices should be selected.

Furthermore, the cost of information collection equipment is typically fixed. However, in this application, it can be adjusted based on the importance of the equipment. The higher the importance, the lower the cost. Essential information collection equipment can be set to zero or negative cost. After this adjustment, the necessary information collection equipment will be installed at each evaluation point, and more important information collection equipment will be installed.

Step S200: Evaluation data containing point tags and time tags is acquired from evaluation equipment installed at the evaluation point, and an evaluation data matrix containing the point tags is constructed. The time tags use relative time, with time zero being the start time of the modification. The number of columns in the evaluation data matrix is equal to the total number of data types, and the number of rows corresponds to time.

Evaluation equipment is installed at the evaluation point, and soil data is acquired based on the evaluation equipment. The acquisition frequency is a preset value. To simplify the process, the acquisition frequency can be set to the same value for all evaluation equipment. A transmission module is provided in the evaluation equipment to upload the acquired data (referred to as evaluation data) to the central terminal. After receiving the evaluation data, the central terminal stores it in a matrix format, referred to as the evaluation data matrix. The evaluation data includes a point tag and a time tag. The point tag indicates the evaluation point at which the data was acquired, and the time tag indicates when the data was acquired. These two tags are used because the data received by the central terminal is out of order due to different transmission speeds. The data needs to be integrated based on these two tags. This integration is achieved by constructing an evaluation data matrix. Specifically, the time tag uses relative time, with time zero being the start time of modification, meaning that time zero is the time when farmland modification begins. The number of columns in the evaluation data matrix is the same as the total number of data types, with each column corresponding to a type of information collection device. The number of rows corresponds to time, with each row corresponding to a moment. The resulting evaluation data matrix is the matrix for each evaluation.

Step S300: Receive an evaluation instruction input by the administrator, extract row data from the evaluation data matrix based on the time the evaluation instruction was input, analyze the extracted row data, and output an evaluation result.

When the administrator needs to evaluate the modification effect, the administrator inputs an evaluation instruction. The execution body of this method locates the corresponding row in the evaluation data matrix based on the time the evaluation instruction was input, extracts the row data, analyzes the row data, and outputs the evaluation result. The analysis of the row data can utilize existing data analysis models or pre-determine certain standard data. The extracted row data is then compared with the standard data to obtain the evaluation result.

Step S400: When receiving the evaluation instruction input by the administrator, remote sensing images are simultaneously acquired. A remote sensing image at the time the modification was initiated is acquired as a baseline image. The baseline image and the remote sensing image are used as features, and the evaluation results are used as labels to train the evaluation model. The application probability of the evaluation model and the application probability of the analysis process of the evaluation data matrix are adjusted based on the error rate of the evaluation model.

In one embodiment of the present invention's technical solution, a remote sensing-based effect evaluation process is introduced. A remote sensing image is acquired at the moment the modification is initiated, serving as a baseline image. When an administrator inputs an evaluation instruction, a remote sensing image is simultaneously acquired. The remote sensing image and the baseline image together form an image group. The differences between the images represent the differences generated during the modification process, which are used as independent variables. The evaluation results based on the evaluation data matrix at the same moment are read as dependent variables. A sample set linking the independent and dependent variables is constructed, which can be used to train a neural network model, called the evaluation model. The evaluation model's function is to derive evaluation results based on the remote sensing images.

Determining the evaluation results based on the evaluation data matrix is real-time. The evaluation model simplifies this process through deep learning, using the evaluation results based on the evaluation data matrix as the true value. The error rate of the evaluation model is then determined. The frequency of use of the two evaluation methods can be adjusted based on the error rate. In extreme cases, the error rate of the evaluation model is zero, at which point the evaluation model is fully utilized, resulting in a fast evaluation process. Furthermore, the information collection equipment is minimally stressed, requiring virtually no data collection and upload, thus extending its service life (most of the information collection equipment in the present invention is consumable).

Regarding the specific working conditions of the technical solution of the present invention, an administrator will regularly perform certain modification measures on a patch of soil. This present invention can remotely and frequently determine the modification effects at each moment and provide timely feedback to the administrator.

Regarding step S100, the steps of receiving the farmland range input by the administrator, randomly selecting evaluation points within the farmland range, and determining the evaluation levels of the evaluation points include:
receiving the farmland range input by the administrator;
gridding the farmland range, and then inserting a grid within the farmland range according to a preset grid size; the left and top edges of the grids are both tangent to the farmland range;
randomly selecting grid nodes as evaluation points and simultaneously determining the evaluation levels of the evaluation points;
updating the selection probability of each grid node, and repeating the selection process repeatedly;
recording the total number of selected evaluation points; and when the total number reaches a preset threshold, outputting the selected evaluation points and their evaluation levels.

The farmland area is input by the administrator. After receiving the farmland area, it is rasterized to generate a bitmap. A grid is then inserted within the rasterized farmland area. The left and top edges of the grid are tangent to the farmland area, and the grid cell size is a preset value. The actual meaning of the grid is very simple, similar to the grid function in some existing mapping software. The purpose of tangency restriction is to predetermine the origin of the grid.

After inserting the grid, grid nodes are randomly selected from the grid as evaluation points. The evaluation level of each evaluation point is simultaneously determined, and the selection probability of each grid node is updated. This selection process is repeated repeatedly; the initial selection probability of each grid node is the same.

Finally, the total number of selected evaluation points is recorded. When a sufficient number of evaluation points are selected, the selected evaluation points and their evaluation levels are output.

Specifically, the process of updating the selection probability of each grid node and repeating the selection process includes:

$$P ( i , j ) = \frac{T ( i , j )}{{\sum }_{i = 1}^{N} {\sum }_{j = 1}^{M} T ( i , j )} ;$$

wherein P (i, j) stands for a selection probability at a grid node (i, j), T(i, j) stands for a feature value at the grid node (i, j), N is a total number of the grid nodes on a transverse direction, M is a total number of the grid nodes on a longitudinal direction; i and j comprise positive integers;

$$T ( i , j ) = α exp \{ - {\sum }_{k = 1}^{K} \frac{{L}_{k}}{{dis}_{k} ( i , j )} \} ;$$

α stands for a preset rectification index, Lₖ comprises a judgment level of a kth judgment point selected; and disₖ(i, j) comprises a distance between the kth judgment point and the grid node (i, j);

Where the grid node (i, j) is selected as the judgment point, L(i, j)=f(T(i, j)); in the formula, L(i, j) comprises the judgment level at the grid node (i, j), f(T(i, j)) comprises a classification function having an independent variable T(i, j) and is an increasing function of T(i, j).

The core of the foregoing content comprises feature values, for any position, calculate the influence of the selected evaluation points on the position. The greater the distance from the evaluation points, the smaller the influence, and the higher the evaluation level of the evaluation point, the greater the influence, that is, the

$$\frac{{L}_{k}}{{dis}_{k} ( i , j )}$$

item in the above content; for any position, superimpose the influence of all evaluation points on it, and compound a decreasing function on the influence, that is, the greater the influence on a certain position, the smaller the probability of being selected, thereby obtaining the selection probability at that position; further, the greater the influence on a certain position, the smaller the probability of being selected, but when it is really selected, the corresponding evaluation level will also be smaller. In this way, the evaluation points can be distributed as evenly as possible, and the distribution of evaluation levels can be more in line with reality (the larger the evaluation level, the higher the cost).

Regarding step S300, the steps of receiving the evaluation instruction input by the administrator, extracting row data from the evaluation data matrix based on the time the evaluation instruction was input, analyzing the extracted row data, and outputting the evaluation result include:
receiving the evaluation instruction input by the administrator and recording the time the evaluation instruction was input;
extracting the row data corresponding to the input time from the evaluation data matrix;
traversing a preset standard data set based on the row data to calculate the matching degree;
using the matching degree as the evaluation result at the input time;

The standard data set is a preset theoretical data range for all data types at different times. The above content defines the specific evaluation process, which includes receiving the evaluation instruction input by the administrator, recording the time the evaluation instruction was input, extracting the row data corresponding to the input time from the evaluation data matrix, traversing a preset standard data set based on the row data, calculating the matching degree, and using the matching degree as the evaluation result at the input time.

The standard data set is a set of standard data ranges for each information collection device, which must include all information collection devices. The standard data for each information collection device is not a fixed value, but rather a range. If the measured data falls within this range, it is considered standard. Each row of data represents a data set captured by an installed information collection device. This data set is compared with the standard data set at the same time to determine whether the data from each information collection device is standard, and a matching degree is then output.

Specifically, the step of calculating the matching degree based on the row data and traversing the preset standard data set includes:
reading the standard data set at the input time;
comparing the row data extracted from the evaluation data matrix with each row of data in the standard row data set to calculate the matching degree;
during the comparison process, the row data extracted from the evaluation data matrix is complemented with the default values.

The above content provides a detailed description of the maximum matching degree calculation process, which includes reading the standard data set at the input time, comparing the row data extracted from the evaluation data matrix with each row of data in the standard row data set, calculating the matching degree, comparing the calculated matching degrees, and outputting the maximum matching degree.

It should be noted that the number of data in the row data is different from the number of data in the standard data set (the row data is the information collection equipment actually installed, and the standard data set is all information collection equipment). Therefore, data filling is required, that is, inserting a data at the missing position in the row data. The inserted data is the default value, such as NULL. When compared, it does not match all ranges. Therefore, it must be non-standard. This also means that the fewer information collection devices installed, the lower the corresponding matching degree. This indirectly raises the evaluation standard for the modification effect, making it more difficult to achieve excellent results (actually very high, but it will also be evaluated as a medium value), prompting administrators to perform more calibrations. On the contrary, if the missing data is evaluated as standard data, then the evaluation process will have no reference significance (not collecting data means full marks).

The matching degree calculation process is as follows: for any data in the row data, the standard data range is searched in the standard data set to determine whether the data falls within the standard data range. If it does, the value is one; if it does not, the value is zero. The number of elements that are one is calculated and divided by the total number of elements in the standard data set to obtain the matching degree.

Regarding step S400, upon receiving the evaluation instruction input by the administrator, simultaneously acquiring remote sensing images, acquiring a remote sensing image at the time of modification startup as a baseline image, using the baseline image and the remote sensing image as features, and the evaluation results as labels, to train an evaluation model; and adjusting the evaluation model application probability and the evaluation model application probability of the evaluation data matrix analysis process based on the evaluation model error rate, including the following steps:
acquiring a remote sensing image at the time of modification startup as a baseline image;
upon receiving the evaluation instruction input by the administrator, simultaneously acquiring a remote sensing image as the remote sensing image at the input time;
using the baseline image and the remote sensing image at the input time as an image group, reading the evaluation results at the input time, and constructing a sample set; wherein the image group is a feature corresponding to the input, and the evaluation results are a label corresponding to the output;
training the evaluation model based on the sample set, and adjusting the evaluation model application probability and the evaluation model application probability of the evaluation data matrix analysis process based on the evaluation model error rate;
the evaluation model application probability is inversely proportional to the error rate, while the evaluation model application probability is directly proportional to the error rate.

In one embodiment of the present invention's technical solution, a remote sensing image is acquired at the time of the modification's initiation as a baseline image. When an administrator inputs an evaluation instruction, a remote sensing image is simultaneously acquired as the remote sensing image at the input time. The baseline image and the remote sensing image at the input time are combined as an image group. The evaluation results at the input time are read, and a sample set is constructed. An evaluation model is trained based on the sample set. The probability of applying the evaluation model and the probability of applying the analysis process of the evaluation data matrix are adjusted based on the evaluation model's error rate. The probability of applying the evaluation model is inversely proportional to the error rate, while the probability of applying the analysis process of the evaluation data matrix is directly proportional.

The above effectively provides an adversarial architecture. When the error rate is sufficiently low, the evaluation model is used to replace the evaluation process based on the information collection device. The advantages of this approach include more convenient and intuitive data acquisition and faster evaluation.

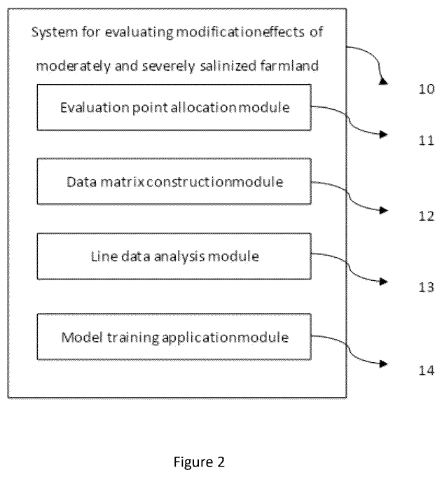

FIG. 2 is a block diagram of the components of a system for evaluating modification effects of moderately to severely salinized farmland. In one embodiment of the present invention, a system 10 for evaluating modification effects of moderately to severely salinized farmland includes:
an evaluation point planning module 11 is configured to receive a farmland range input by an administrator, randomly select evaluation points within the range, and determine the evaluation level of each evaluation point; the evaluation level is used to determine the data type of the data to be acquired at the evaluation point;
a data matrix construction module 12 is configured to acquire evaluation data containing point tags and time tags based on evaluation equipment installed at the evaluation points, and construct an evaluation data matrix containing the point tags; the time tags use relative time, with time zero being the start time of the modification; The number of columns in the evaluation data matrix is the same as the total number of data types, and the number of rows corresponds to time.
a row data analysis module 13, configured to receive evaluation instructions input by an administrator, extract row data from the evaluation data matrix based on the time the evaluation instruction was input, analyze the extracted row data, and output an evaluation result.
a model training and application module 14, configured to simultaneously acquire remote sensing images upon receiving the evaluation instruction input by the administrator, obtain a remote sensing image at the time the modification was initiated, use it as a baseline image, train an evaluation model using the baseline image and remote sensing image as features, and use the evaluation results as labels. The evaluation model's application probability and the application probability of the evaluation data matrix analysis process are adjusted based on the evaluation model's error rate.

Furthermore, the evaluation point planning module 11 includes:
a range receiving unit for receiving the farmland range input by the administrator;
a grid insertion unit for rasterizing the farmland range and then inserting grids within the range according to a preset cell size; the left and top edges of the grids are tangent to the farmland range;
a random selection unit for randomly selecting grid nodes as evaluation points and simultaneously determining the evaluation level of each evaluation point;
a loop execution unit for updating the selection probability of each grid node and looping through the selection process;
a first output unit for recording the total number of selected evaluation points. When the total number reaches a preset threshold, the selected evaluation point and its evaluation level are output.

Specifically, the row data analysis module 13 includes:
an instruction receiving unit, configured to receive evaluation instructions input by an administrator and record the time the evaluation instructions were input;
a row data extraction unit, configured to extract the row data corresponding to the input time from the evaluation data matrix;
a traversal matching unit, configured to traverse a preset standard data set based on the row data and calculate the matching degree;
a first output unit, configured to output the matching degree as the evaluation result at the input time.

The standard data set is a preset theoretical data range for all data types at different times. Furthermore, the model training application module 14 includes:
a baseline image acquisition unit, for acquiring a remote sensing image at the time of modification initiation as the baseline image;
a real-time image acquisition unit, for synchronously acquiring a remote sensing image as the remote sensing image at the time of input when receiving an evaluation instruction input by an administrator;
a sample set construction unit, for combining the baseline image and the remote sensing image at the time of input as an image group, reading the evaluation results at the time of input, and constructing a sample set; wherein the image set is a feature corresponding to the input, and the evaluation results are labels corresponding to the output;
an application probability update unit, for training an evaluation model based on the sample set and adjusting the application probability of the evaluation model and the application probability of the analysis process of the evaluation data matrix based on the error rate of the evaluation model;
wherein, the application probability of the evaluation model is inversely proportional to the error rate, and the application probability of the analysis process of the evaluation data matrix is directly proportional.

The foregoing description is merely a preferred embodiment of the present invention and is not intended to limit the present invention. Any modifications, equivalent substitutions, and modifications made within the spirit and principles of the present invention are intended to be included within the scope of protection of the present invention.

1. A method for evaluating modification effects of moderately and severely salinized farmland, wherein the method comprising:
receiving a farmland input by an administrator, selecting judgment points in the farmland randomly, and determining levels of the judgment points; wherein the levels are configured to determine data types of data to be acquired at the judgment points;
acquiring judgment data containing point tags and time tags based on judgment devices installed on the judgment points, building a judgment data matrix containing the point tags; the time tags adopt relative time, and a zero moment comprises a moment when modification is started;
receiving judgment instructions from the administrator, extracting line data in the judgment data matrix based on the time when the judgment instructions are input, analyzing the line data extracted and outputting judgment results;
upon receipt of the judgment instructions from the administrator, acquiring remote sensing images synchronously, acquiring a remote sensing image at the moment when the modification is started as a baseline image, taking the baseline image and the remote sensing image as features, taking the judgment results as tags, and training a judgment model; adjusting an application probability of the judgment model and an application probability of an analysis process of the judgment data matrix according to an error rate of the judgment model;
wherein receiving the judgment instruction from the administrator, extracting line data from the judgment data matrix based on the time when the judgment instruction is input, analyzing the extracted line data, and outputting the judgment results comprises:
receiving the judgment instruction from the administrator, recording the moment when the judgment instruction is input;
extracting line data corresponding to the input moment;
reading the standard data set at the input moment;
comparing the line data extracted from the judgment data matrix with the line data in a standard line data set and calculating a matching degree;
wherein, during comparison, complementing rows for the line data extracted from the judgment data matrix, and elements to be complemented comprise preset default values
using the matching degree as the judgment result at the input moment;
wherein the standard data set comprises a theoretical data range of all data types in different moments.

2. The method for evaluating modification effects of moderately and severely salinized farmland according to claim 1, wherein receiving the farmland range input by the administrator, selecting judgment points randomly in the farmland range and determining the levels of the judgment points comprise:
receiving the farmland range input by the administrator;
rasterizing the farmland range, inserting a grid in the farmland range according to a predetermined unit size; lines at a left edge and an upper edge of the grid are tangent to the farmland range;
selecting nodes of the grid randomly as the judgment points, determining the levels of the judgment points;
updating a selection probability of the nodes of the grid and executing selection processes cyclically;
recording a total number of the judgment points selected, where the total number reaches a predetermined threshold, outputting the selected judgment points and the judgment levels thereof.

3. The method for evaluating modification effects of moderately and severely salinized farmland according to claim 2, wherein updating the selection probability of the nodes of the grid and executing selection processes thereof comprises:
$$P ( i , j ) = \frac{T ( i , j )}{{\sum }_{i = 1}^{N} {\sum }_{j = 1}^{M} T ( i , j )} ;$$
stands for a feature value at the grid node (i, j), N is a total number of the grid nodes on a transverse direction, M is a total number of the grid nodes on a longitudinal direction; i and j comprise positive integers;
$$T ( i , j ) = α exp \{ - {\sum }_{k = 1}^{K} \frac{{L}_{k}}{{dis}_{k} ( i , j )} \} ;$$
a stands for a preset rectification index, Lₖ comprises a judgment level of a kth judgment point selected; and disₖ(i, j) comprises a distance between the kth judgment point and the grid node (i, j);
where the grid node (i, j) is selected as the judgment point, L(i, j)=f(T(i, j)); in the formula, L(i, j) comprises the judgment level at the grid node (i, j), f(T(i, j)) comprises a classification function having an independent variable T(i, j) and is an increasing function of T(i, j).

4. (canceled)

5. (canceled)

6. The method for evaluating modification effects of moderately and severely salinized farmland according to claim 1, wherein upon receipt of the judgment instruction from the administrator, acquiring the remote sensing images synchronously, acquiring the remote sensing image at a moment when modification is initiated as the baseline image, taking the baseline image and the remote sensing image as features, taking the judgment results as tags and training the judgment model; adjusting the application probability of the judgment model and the application probability of analysis of the judgment data matrix according to the error rate of the judgment model comprises:
acquiring the remote sensing image at the moment when the modification is initiated as the baseline image;
receiving the judgment instruction input by the administrator, acquiring the remote sensing images synchronously as the remote sensing image at the input moment;
taking the baseline image and the remote sensing image at the input moment as an image set, reading the judgment results at the input moment, and building a sample set; wherein the image set is a feature corresponding to an input, the judgment results comprise tags corresponding to an output;
training the judgment model based on the sample set and adjusting the application probability of the judgment model and the application probability of the analysis process of the judgment data matrix according to the error rate of the judgment model;
wherein the application probability of the judgment model varies inversely with the error rate, and the application probability of the analysis process of the judgment data matrix varies in direct proportion to the error rate.

7. A system for evaluating modification effects of moderately and severely salinized farmland, wherein the system comprises:
a judgment point allocating module, configured to receive the farmland range input by the administrator, select judgment points randomly in the farmland range and determining the levels of the judgment points; wherein the levels are configured to determine data types of the data to be acquired at the judgment points;
a data matrix building module, configured to acquire the judgment data containing the point tags and the time tags using judgment devices installed on the judgment points, and building a judgment data matrix containing the point tags; wherein the time tags use relative time, a zero moment is the moment the modification is initiated; a row number of the judgment data matrix is the same as a total number of the data types, and the line number corresponds to the time;
a line data analysis module, configured to receive the judgment instruction input by the administrator, extracting line data from the judgment data matrix based on the input moment of the judgment instruction, analyzing the extracted line data and outputting judgment results;
a model training application module, configured to acquire remote sensing images upon receipt of the judgment instruction input by the administrator, acquire the remote sensing images at the moment when the modification is initiated as the baseline image, take the baseline image and the remote sensing images as the feature, take the judgment results as the tags, and train the judgment model; and adjust the application probability of the judgment model and the application probability of the analysis process of the judgment data matrix according to the error rate of the judgment model;
wherein the line data analysis module comprises
an instruction receipt unit, configured to receive the judgment instruction input by the administrator, and record the input moment of the judgment instruction;
a line data extraction unit, configured to extract line data corresponding to the input moment from the judgment data matrix;
a traversing matching unit, configured to traverse the preset standard dataset and calculate a matching degree;
a first input unit, configured to take the matching degree as the judgment results of the input moment;
wherein the standard dataset comprises a preset theoretical data range of all the data at different times;
traversing the preset standard data set based on the line data and calculating the matching degree comprises:
reading the standard data set at the input moment;
comparing the line data extracted from the judgment data matrix with the line data in a standard line data set and calculating a matching degree;
wherein, during comparison, complementing rows for the line data extracted from the judgment data matrix, and elements to be complemented comprise preset default values.

8. The system for evaluating modification effects of moderately and severely salinized farmland according to claim 7, wherein the judgment point allocating module comprises:
a range receiving unit, configured to receive the farmland range input by the administrator;
a grid input unit, configured to rasterize the farmland range, and insert a grid on the farmland range according to the preset unit size; and lines at a left edge and an upper edge of the grid are tangent to the farmland range;
a random selection unit, configured to select grid nodes randomly as the judgment points and determine the judgment levels of the judgment points synchronously;
a cyclic execution unit, configured to update a selection probability of the grid nodes and execution the selection process periodically;
a first input unit, configured to record a total number of the judgment points selected, and when the total number reaches a preset threshold, outputting the judgment points selected and the judgment levels thereof.

9. (canceled)

10. The system for evaluating modification effects of moderately and severely salinized farmland according to claim 7, wherein the model training application module comprises:
a baseline image acquisition unit, configured to acquire the remote sensing images at the initiating moment as the baseline image;
a real-time image acquisition unit, configured to acquire the remote sensing images synchronously upon receipt of the judgment instruction input by the administrator as the remote sensing image at the input moment;
a sample set construction unit, configured to take the baseline image and the remote sensing image at the input moment as the image set, read the judgment results at the input moment, and build a sample set; wherein the image set corresponds to a feature, which is an input and the judgment result is a tag, corresponds to an output;
an application probability updating unit, configured to train the judgment model based on the sample set, and adjust the application probability of the judgment model and the application probability of the analysis process of the judgment data matrix according to the error rate of the judgment model;
wherein the application probability of the judgment model varies inversely with the error rate, and the application probability of the analysis process of the judgment data matrix is in direct proportion to the error rate of the judgment model.
